(19) United States
(12) Patent Application Publication
(10) Pub. No.: US 2024/0280918 A1
(43) Pub. Date: Aug. 22, 2024

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Yuki OYAMADA, Kanagawa (JP); Masahiro IWASAKI, Kanagawa (JP); Yoichi KIGOSHI, Kanagawa (JP); Keisuke KUSANO, Kanagawa (JP); Kenta IDE, Kanagawa (JP)

(73) Assignee: FUJIFILM Business Innovation Corp., Tokyo (JP)

(21) Appl. No.: 18/448,964

(22) Filed: Aug. 13, 2023

(30) Foreign Application Priority Data
Feb. 13, 2023 (JP) 2023-020272

(51) Int. Cl. G03G 5/07; G03G 5/047; G03G 5/06

(52) U.S. Cl. CPC G03G 5/078; G03G 5/047; G03G 5/0696

(57) ABSTRACT

An electrophotographic photoreceptor includes a conductive substrate, and a lamination type photosensitive layer disposed on the conductive substrate and including a charge generation layer and a charge transport layer, in which the charge transport layer contains polyalkylsiloxane, and an amount of a cyclic siloxane having a molecular weight of 450 or less in the charge transport layer is less than 0.1 ppm.

### CROSS-REFERENCE TO RELATED APPLICATIONS

This application is based on and claims priority under 35 USC 119 from Japanese Patent Application No. 2023-020272 filed Feb. 13, 2023.

### BACKGROUND

### (i) Technical Field

The present disclosure relates to an electrophotographic photoreceptor, a process cartridge, and an image forming apparatus.

### (ii) Related Art

JP1991-121457A discloses a coating material for an electrophotographic photoreceptor that contains a volatile leveling agent volatilized by being heated after application.

JP2002-341570A discloses an electrophotographic photoreceptor including a support substrate, and an interlayer and a photosensitive layer that are provided on the support substrate, in which the interlayer contains a binder resin and a charge transport agent having a molecular weight of 400 or greater.

### SUMMARY

Aspects of non-limiting embodiments of the present disclosure relate to an electrophotographic photoreceptor, a process cartridge, and an image forming apparatus that are unlikely to cause spot-like image defects and image unevenness as compared with an electrophotographic photoreceptor including a charge transport layer that contains 0.1 ppm or greater of a cyclic siloxane with a molecular weight of 450 or less or an electrophotographic photoreceptor including a single layer type photosensitive layer that contains 0.1 ppm or greater of a cyclic siloxane with a molecular weight of 450 or less.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above-described object includes the following aspects.

According to an aspect of the present disclosure, there is provided an electrophotographic photoreceptor including: a conductive substrate; and a lamination type photosensitive layer disposed on the conductive substrate and including a charge generation layer and a charge transport layer, in which the charge transport layer contains polyalkylsiloxane, and an amount of a cyclic siloxane having a molecular weight of 450 or less in the charge transport layer is less than 0.1 ppm.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to a first exemplary embodiment;

FIG. 2 is a partial cross-sectional view showing an example of a layer configuration of an electrophotographic photoreceptor according to a second exemplary embodiment;

FIG. 3 is a schematic configuration view showing an example of an image forming apparatus according to the present exemplary embodiment; and

FIG. 4 is a schematic configuration view showing another example of an image forming apparatus according to the present exemplary embodiment.

### DETAILED DESCRIPTION

Hereinafter, exemplary embodiments of the present disclosure will be described. The following descriptions and examples merely illustrate the exemplary embodiments, and do not limit the scope of the exemplary embodiments.

In the present disclosure, a numerical range shown using “to” indicates a range including numerical values described before and after “to” as a minimum value and a maximum value.

In a numerical range described in a stepwise manner in the present disclosure, an upper limit value or a lower limit value described in a certain numerical range may be replaced with an upper limit value or a lower limit value in another numerical range described in a stepwise manner. Further, in a numerical range described in the present disclosure, an upper limit value or a lower limit value described in the numerical range may be replaced with a value shown in Examples.

In the present disclosure, the meaning of the term “step” includes not only an independent step but also a step whose intended purpose is achieved even in a case where the step is not clearly distinguished from other steps.

In the present disclosure, in a case where an exemplary embodiment is described with reference to drawings, the configuration of the exemplary embodiment is not limited to the configuration shown in the drawings. In addition, the sizes of members in each drawing are conceptual, and a relative relation in the sizes between the members is not limited thereto.

In the present disclosure, each component may include a plurality of kinds of substances corresponding to each component. In the present disclosure, in a case where a plurality of kinds of substances corresponding to each component in a composition are present, the amount of each component in the composition indicates the total amount of the plurality of kinds of substances present in the composition unless otherwise specified.

In the present disclosure, each component may include a plurality of kinds of particles corresponding to each component. In a case where a plurality of kinds of particles corresponding to each component are present in a composition, the particle diameter of each component indicates the value of a mixture of the plurality of kinds of particles present in the composition, unless otherwise specified.

In the present disclosure, an alkyl group and an alkylene group are any of linear, branched, or cyclic unless otherwise specified.

In the present disclosure, a hydrogen atom in an organic group, an aromatic ring, a linking group, an alkyl group, an alkylene group, an aryl group, an aralkyl group, an alkoxy group, an aryloxy group, or the like may be substituted with a halogen atom.

In the present disclosure, in a case where a compound is represented by a structural formula, the compound may be represented by a structural formula in which symbols (C and H) representing a carbon atom and a hydrogen atom in a hydrocarbon group and/or a hydrocarbon chain are omitted.

In the present disclosure, the term “constitutional unit” of a copolymer or a resin has the same definition as that for a monomer unit.

In the present disclosure, ppm stands for parts per million and is on a mass basis.

### Electrophotographic Photoreceptor

The present disclosure provides a first exemplary embodiment and a second exemplary embodiment of an electrophotographic photoreceptor (hereinafter, also referred to as “photoreceptor”).

The photoreceptor according to the first exemplary embodiment includes a conductive substrate, and a lamination type photosensitive layer disposed on the conductive substrate and including a charge generation layer and a charge transport layer. The photoreceptor according to the first exemplary embodiment may further include other layers (for example, an undercoat layer and an interlayer).

The photoreceptor according to the second exemplary embodiment includes a conductive substrate, and a single layer type photosensitive layer disposed on the conductive substrate. The photoreceptor according to the second exemplary embodiment may further include other layers (for example, an undercoat layer and an interlayer).

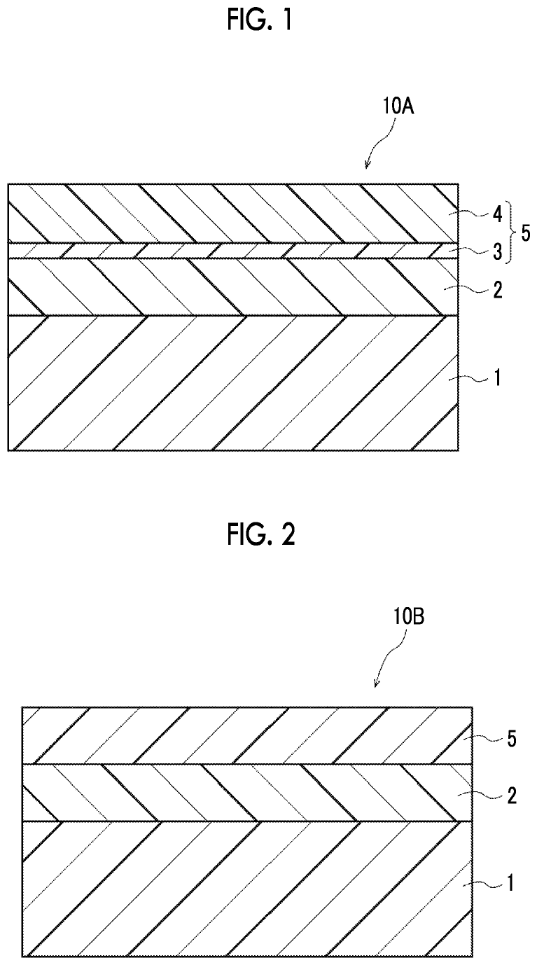

FIG. 1 is a partial cross-sectional view schematically showing an example of the layer configuration of the photoreceptor according to the first exemplary embodiment. A photoreceptor 10A shown in FIG. 1 includes a lamination type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation type photosensitive layer). The photoreceptor 10A may include an interlayer (not shown) between the undercoat layer 2 and the charge generation layer 3. The undercoat layer 2 may or may not be present.

FIG. 2 is a partial cross-sectional view schematically showing an example of the layer configuration of the photoreceptor according to the second exemplary embodiment. A photoreceptor 10B shown in FIG. 2 includes a single layer type photosensitive layer. The photoreceptor 10B has a structure in which the undercoat layer 2 and the photosensitive layer 5 are laminated in this order on the conductive substrate 1. The photoreceptor 10B may include an interlayer (not shown) between the undercoat layer 2 and the photosensitive layer 5. The undercoat layer 2 may or may not be present.

In the photoreceptor according to the first exemplary embodiment, the charge transport layer contains polyalkylsiloxane, and the amount of a cyclic siloxane having a molecular weight of 450 or less in the charge transport layer is less than 0.1 ppm.

In the photoreceptor according to the second exemplary embodiment, the single layer type photosensitive layer contains polyalkylsiloxane, and the amount of a cyclic siloxane having a molecular weight of 450 or less in the single layer type photosensitive layer is less than 0.1 ppm.

In the present disclosure, “cyclic siloxane having a molecular weight of 450 or less” denotes hexamethylcyclotrisiloxane, octamethylcyclotetrasiloxane, decamethylcyclopentasiloxane, and dodecamethylcyclohexasiloxane.

The expression “amount of the cyclic siloxane having a molecular weight of 450 or less is less than 0.1 ppm” denotes that the total amount of hexamethylcyclotrisiloxane, octamethylcyclotetrasiloxane, decamethylcyclopentasiloxane, and dodecamethylcyclohexasiloxane is less than 0.1 ppm.

Hereinafter, the cyclic siloxane having a molecular weight of 450 or less will be referred to as “low-molecular-weight cyclic siloxane”.

The hexamethylcyclotrisiloxane, the octamethylcyclotetrasiloxane, the decamethylcyclopentasiloxane, and the dodecamethylcyclohexasiloxane will also be referred to as D3, D4, D5, and D6, respectively.

Hereinafter, in a case of description common to the first exemplary embodiment and the second exemplary embodiment, both exemplary embodiments are collectively referred to as the present exemplary embodiment.

In the photoreceptor according to the present exemplary embodiment, spot-like image defects and image unevenness are unlikely to occur. The mechanism is assumed as follows.

In a case where the photosensitive layer is formed by being coated with a liquid composition and dried, the liquid composition may contain polyalkylsiloxane as a leveling agent. In a case where the polyalkylsiloxane contains the low-molecular-weight cyclic siloxane, a portion where the low-molecular-weight cyclic siloxane is present is rapidly dried, and thus the layer thickness of the photosensitive layer of the portion is relatively thin, which may cause spot-like image defects and image unevenness.

Therefore, in the present exemplary embodiment, the amount of the low-molecular-weight cyclic siloxane contained in the liquid composition (containing polyalkylsiloxane as a leveling agent) used for forming the photosensitive layer is reduced. As a result, in the present exemplary embodiment, the amount of the low-molecular-weight cyclic siloxane contained in the charge transport layer or the single layer type photosensitive layer is less than 0.1 ppm.

In the present exemplary embodiment, the mass of the low-molecular-weight cyclic siloxane contained in the charge transport layer or the single layer type photosensitive layer is measured using a gas chromatograph-mass spectrometer.

Each standard sample of D3, D4, D5, and D6 is prepared in advance, the retention time in a case of heating and vaporizing the sample at 300° C. is measured, and a calibration curve including a region where the amount of each sample is in a range of 0.05 ppm to 5 ppm is prepared.

The charge transport layer (or the single layer type photosensitive layer) is peeled off from the photoreceptor and weighed accurately. The peeled layer is placed in a vial and heated at 300° C., and the retention time of volatile components is measured. Based on the peak area and the calibration curve of the components appearing on the chromatograph, each amount of D3, D4, D5, and D6 is acquired, and the acquired amounts are summed.

In the photoreceptor according to the first exemplary embodiment, from the viewpoint of further suppressing spot-like image defects and image unevenness, for example, it is preferable that the amount of the low-molecular-weight cyclic siloxane in the charge transport layer is as small as possible and most preferable that the charge transport layer does not contain the low-molecular-weight cyclic siloxane. The expression “does not contain the low-molecular-weight cyclic siloxane” denotes that the low-molecular-weight cyclic siloxane is not detected by the above-described measuring method.

In the photoreceptor according to the second exemplary embodiment, from the viewpoint of further suppressing spot-like image defects and image unevenness, for example, it is preferable that the amount of the low-molecular-weight cyclic siloxane in the single layer type photosensitive layer is as small as possible and most preferable that the single layer type photosensitive layer does not contain the low-molecular-weight cyclic siloxane. The expression “does not contain the low-molecular-weight cyclic siloxane” denotes that the low-molecular-weight cyclic siloxane is not detected by the above-described measuring method.

Examples of a method of controlling the amount of the low-molecular-weight cyclic siloxane contained in the charge transport layer or the single layer type photosensitive layer to less than 0.1 ppm include a method of performing a high-temperature treatment on polyalkylsiloxane used as a leveling agent in formation of the layer in advance and volatilizing and removing the low-molecular-weight cyclic siloxane having a relatively low boiling point.

Specific examples of the high-temperature treatment include a treatment of placing polyalkylsiloxane in a drying furnace having a temperature of 280° C. or higher and 320° C. or lower for 3 hours or longer and 5 hours or shorter.

### Polyalkylsiloxane

The charge transport layer of the first exemplary embodiment and the single layer type photosensitive layer of the second exemplary embodiment contain polyalkylsiloxane as a leveling agent. The polyalkylsiloxane is a molecule formed only of a siloxane bond and an alkyl group.

From the viewpoint that the volatilization does not occur due to the high-temperature treatment described above and functions as a leveling agent are exhibited, the weight-average molecular weight of the polyalkylsiloxane is, for example, preferably 1,000 or greater and 20,000 or less, more preferably 2,000 or greater and 15,000 or less, and still more preferably 3,000 or greater and 12,000 or less.

Examples of the alkyl group contained in the polyalkylsiloxane include a linear alkyl group having 1 or more and 10 or less carbon atoms (for example, preferably 1 or more and 6 or less carbon atoms, more preferably 1 or more and 3 or less carbon atoms, and still more preferably 1 or 2 carbon atoms), a branched alkyl group having 3 or more and 10 or less carbon atoms (for example, preferably 3 or more and 6 or less carbon atoms and more preferably 3 or 4 carbon atoms), and a cyclic alkyl group having 3 or more and 10 or less carbon atoms (for example, preferably 3 or more and 6 or less carbon atoms and more preferably 3 or 4 carbon atoms). Among these, for example, an alkyl group having 1 or more and 3 or less carbon atoms is preferable, at least one of a methyl group or an ethyl group is more preferable, and a methyl group is still more preferable. The number of kinds of a plurality of alkyl groups in one molecule of the polyalkylsiloxane may be one or two or more.

In the first exemplary embodiment, the total content of the polyalkylsiloxane contained in the charge transport layer is, for example, preferably 1 ppm or greater and 10 ppm or less, more preferably 1 ppm or greater and 8 ppm or less, and still more preferably 1 ppm or greater and 6 ppm or less with respect to the mass of the entire layer.

In the second exemplary embodiment, the total content of the polyalkylsiloxane contained in the single layer type photosensitive layer is, for example, preferably 1 ppm or greater and 10 ppm or less, more preferably 1 ppm or greater and 8 ppm or less, and still more preferably 1 ppm or greater and 6 ppm or less with respect to the mass of the entire layer.

Hereinafter, each layer of the photoreceptor according to the present exemplary embodiment will be described in detail.

### Conductive Substrate

Examples of the conductive substrate include metal plates containing metals (such as aluminum, copper, zinc, chromium, nickel, molybdenum, vanadium, indium, gold, and platinum) or alloys (such as stainless steel), metal drums, metal belts, and the like. Further, examples of the conductive substrate include paper, a resin film, a belt, and the like obtained by being coated, vapor-deposited or laminated with a conductive compound (such as a conductive polymer or indium oxide), a metal (such as aluminum, palladium, or gold) or an alloy. Here, the term “conductive” denotes that the volume resistivity is less than 1×10¹³ Ωcm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. In a case where incoherent light is used as a light source, roughening of the surface to prevent interference fringes is not particularly necessary, and it is appropriate for longer life because occurrence of defects due to the unevenness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by anodization is chemically active in a natural state, is easily contaminated, and has a large resistance fluctuation depending on the environment. Therefore, for example, it is preferable that a sealing treatment is performed on the porous anodized film so that the fine pores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the blending ratio of phosphoric acid, chromic acid, and hydrofluoric acid to the acidic treatment liquid, for example, the concentration of the phosphoric acid is 10% by mass or greater and 11% by mass or less, the concentration of the chromic acid is 3% by mass or greater and 5% by mass or less, and the concentration of the hydrofluoric acid is 0.5% by mass or greater and 2% by mass or less, and the concentration of all these acids may be 13.5% by mass or greater and 18% by mass or less. The treatment temperature is, for example, preferably 42° C. or higher and 48° C. or lower. The film thickness of the coating film is, for example, preferably 0.3 μm or greater and 15 μm or less.

The boehmite treatment is carried out, for example, by immersing the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. The film thickness of the coating film is, for example, preferably 0.1 μm or greater and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 1×10² Ωcm or greater and 1×10¹¹ Ωcm or less.

As the inorganic particles having the above-described resistance value, for example, metal oxide particles such as tin oxide particles, titanium oxide particles, zinc oxide particles, and zirconium oxide particles may be used, and zinc oxide particles are particularly preferable.

The specific surface area of the inorganic particles measured by the BET method may be, for example, 10 m²/g or greater.

The volume average particle diameter of the inorganic particles may be, for example, 50 nm or greater and 2,000 nm or less (for example, preferably 60 nm or greater and 1,000 nm or less).

The content of the inorganic particles is, for example, preferably 10% by mass or greater and 80% by mass or less and more preferably 40% by mass or greater and 80% by mass or less with respect to the amount of the binder resin.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, a silane coupling agent containing an amino group and another silane coupling agent may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

The treatment amount of the surface treatment agent is, for example, preferably 0.5% by mass or greater and 10% by mass or less with respect to the amount of the inorganic particles.

Here, the undercoat layer may contain an electron-accepting compound (acceptor compound) together with the inorganic particles, for example, from the viewpoint of enhancing the long-term stability of the electrical properties and the carrier blocking properties.

Examples of the electron-accepting compound include electron-transporting substances, for example, a quinone-based compound such as chloranil or bromanil; a tetracyanoquinodimethane-based compound; a fluorenone compound such as 2,4,7-trinitrofluorenone or 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, or 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable, and specifically, for example, anthraquinone, alizarin, quinizarin, anthrarufin, or purpurin is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of each inorganic particle by adding the electron-accepting compound dropwise to inorganic particles directly or by dissolving the electron-accepting compound in an organic solvent while stirring the inorganic particles with a mixer having a large shearing force and spraying the mixture together with dry air or nitrogen gas. The electron-accepting compound may be added dropwise or sprayed, for example, at a temperature lower than or equal to the boiling point of the solvent. After the dropwise addition or the spraying of the electron-accepting compound, the compound may be further baked at 100° C. or higher. The baking is not particularly limited as long as the temperature and the time are adjusted such that the electrophotographic characteristics can be obtained.

The wet method is, for example, a method of attaching the electron-accepting compound to the surface of each inorganic particle by adding the electron-accepting compound to inorganic particles while dispersing the inorganic particles in a solvent using a stirrer, ultrasonic waves, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that the electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

The electron-accepting compound may be attached to the surface before or after the inorganic particles are subjected to a surface treatment with a surface treatment agent or simultaneously with the surface treatment performed on the inorganic particles with a surface treatment agent.

The content of the electron-accepting compound may be, for example, 0.01% by mass or greater and 20% by mass or less and preferably 0.01% by mass or greater and 10% by mass or less with respect to the amount of the inorganic particles.

Examples of the binder resin used for the undercoat layer include known polymer compounds such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin, a zirconium chelate compound, a titanium chelate compound, an aluminum chelate compound, a titanium alkoxide compound, an organic titanium compound, and known materials such as a silane coupling agent.

Examples of the binder resin used for the undercoat layer include a charge-transporting resin containing a charge-transporting group, and a conductive resin (such as polyaniline).

Among these, as the binder resin used for the undercoat layer, for example, a resin insoluble in a coating solvent of the upper layer is preferable, and a resin obtained by reaction between a curing agent and at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary.

The undercoat layer may contain various additives for improving the electrical properties, the environmental stability, and the image quality.

Examples of the additives include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

The undercoat layer may have, for example, a Vickers hardness of 35 or greater.

The surface roughness (ten-point average roughness) of the undercoat layer may be adjusted, for example, to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. Further, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming an undercoat layer include known methods such as a roll mill, a ball mill, a vibration ball mill, an attritor, a sand mill, a colloid mill, and a paint shaker.

Examples of the method of coating the conductive substrate with the coating solution for forming an undercoat layer include typical coating methods such as a blade coating method, a wire bar coating method, a spray coating method, a dip coating method, a bead coating method, an air knife coating method, and a curtain coating method.

The average thickness of the undercoat layer is set to, for example, preferably 15 μm or greater and more preferably in a range of 20 μm or greater and 50 μm or less.

### Interlayer

The interlayer is, for example, a layer containing a resin. Examples of the resin used for the interlayer include a polymer compound, for example, an acetal resin (such as polyvinyl butyral), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, or a melamine resin.

The interlayer may be a layer containing an organometallic compound. Examples of the organometallic compound used for the interlayer include an organometallic compound containing metal atoms such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical coating methods such as a dip coating method, a push-up coating method, a wire bar coating method, a spray coating method, a blade coating method, an air knife coating method, and a curtain coating method.

The average thickness of the interlayer is set to be, for example, preferably in a range of 0.1 μm or greater and 3 μm or less. The interlayer may be used as the undercoat layer.

### Charge Generation Layer

The charge generation layer is, for example, a layer containing a charge generation material and a binder resin. Further, the charge generation layer may be a deposition layer of the charge generation material. The deposition layer of the charge generation material is, for example, preferable in a case where an incoherent light source such as a light emitting diode (LED) or an organic electroluminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine-based pigment; zinc oxide; trigonal selenium; a thioindigo-based pigment; and a porphyrazine compound.

In the photoreceptor according to the first exemplary embodiment, for example, it is preferable that the charge generation layer contains a phthalocyanine-based pigment as the charge generation material. As the phthalocyanine-based pigment contained in the charge generation layer, for example, at least one selected from the following phthalocyanine group is preferable.

Phthalocyanine group: Y-titanyl phthalocyanine having diffraction peaks where Bragg angles (2θ+0.5°) in an X-ray diffraction spectrum using Cuka characteristic X-rays are at least 9.5° and 27.3°, B-titanyl phthalocyanine having diffraction peaks where the Bragg angles are at least 7.5° and 28.6°, hydroxygallium phthalocyanine having diffraction peaks where the Bragg angles are at least 7.8° and 28.6°, and chlorogallium phthalocyanine having diffraction peaks where the Bragg angles are at least 7.9° and 28.8°.

Even among the above-described phthalocyanine-based pigments, for example, at least one selected from the following phthalocyanine group is more preferable.

Phthalocyanine group: hydroxygallium phthalocyanine having diffraction peaks where Bragg angles (2θ+0.5°) in an X-ray diffraction spectrum using Cuka characteristic X-rays are at least 7.8° and 28.6° and chlorogallium phthalocyanine having diffraction peaks where the Bragg angles are at least 7.9° and 28.8°.

A method of identifying the charge generation material contained in the charge generation layer (or the single layer type photosensitive layer) is as follows.

The photoreceptor is separated into the conductive substrate and the laminate on the conductive substrate.

The layer on the outer peripheral side of the charge generation layer (or the single layer type photosensitive layer) is peeled off from the laminate to obtain a sample (1) consisting of the remaining layers. X-ray diffraction of the sample (1) is performed under the following conditions.
X-ray diffractometer: for example, D8 DISCOVER (Bruker AXS Co., Ltd.)
X-ray source: CuKα
Measuring method: 2θ/θ scan Next, only the charge generation layer (or the single layer type photosensitive layer) is removed from the sample (1) to obtain a sample (2) consisting of the remaining layers. Examples of a method of removing only the charge generation layer (or the single layer type photosensitive layer) from the sample (1) include a method of washing the sample (1) with a solvent that can dissolve the binder resin of the charge generation layer (or the single layer type photosensitive layer). The X-ray diffraction of the sample (2) is performed under the same conditions as the conditions for the X-ray diffraction of the sample (1).

The X-ray diffraction peak obtained by removing the X-ray diffraction peak of the sample (2) from the X-ray diffraction profile of the sample (1) is defined as the X-ray diffraction peak of the charge generation material, and the charge generation material is identified at the position of this X-ray diffraction peak.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (a polycondensate of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” denotes that the volume resistivity is 1×10¹³ Ωcm or greater. These binder resins may be used alone or in the form of a mixture of two or more kinds thereof.

The blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. The charge generation layer may be formed by vapor deposition of the charge generation material. The formation of the charge generation layer by vapor deposition is, for example, particularly appropriate in a case where a fused ring aromatic pigment or a perylene pigment is used as the charge generation material.

Examples of the solvent for preparing the coating solution for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming a charge generation layer, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type homogenizer in which a dispersion liquid is dispersed by a liquid-liquid collision or a liquid-wall collision in a high-pressure state, and a penetration type homogenizer in which a dispersion liquid is dispersed by penetrating the liquid through a fine flow path in a high-pressure state. During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The average thickness of the charge generation layer is set to be, for example, preferably in a range of 0.1 μm or greater and 5.0 μm or less and more preferably in a range of 0.2 μm or greater and 2.0 μm or less.

### Charge Transport Layer

The charge transport layer contains polyalkylsiloxane. The form of the polyalkylsiloxane is as described above.

The charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound. These charge transport materials may be used alone or in combination of two or more kinds thereof, but are not limited thereto.

From the viewpoint of the charge mobility, for example, a triarylamine derivative represented by Structural Formula (a-1) or a benzidine derivative represented by Structural Formula (a-2) is preferable as the charge transport material.

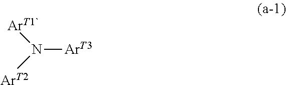

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

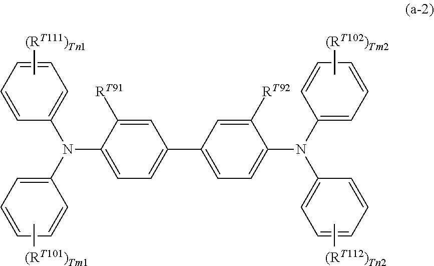

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, RT¹¹¹, and R^{T112} each independently represent a halogen atom, an alkyl group having 1 or more and 5 or less carbon atoms, an alkoxy group having 1 or more and 5 or less carbon atoms, a substituted amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or greater and 2 or less.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” and a benzidine derivative having “—CH═CH—CH═C(R^{T15})(R^{T16})” are particularly preferable from the viewpoint of the charge mobility.

As the polymer charge transport material, known materials having charge transport properties, such as poly-N-vinylcarbazole and polysilane, can be used. Particularly, for example, a polyester-based polymer charge transport material is particularly preferable. The polymer charge transport material may be used alone or in combination of binder resins.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among these, for example, a polycarbonate resin or a polyarylate resin is preferable as the binder resin. These binder resins may be used alone or in combination of two or more kinds thereof.

The blending ratio between the charge transport material and the binder resin is, for example, preferably 10:1 to 1:5 in terms of the mass ratio.

The charge transport layer may also contain other known additives.

The formation of the charge transport layer is not particularly limited, and a known forming method is used. For example, a coating film of a coating solution for forming a charge transport layer in which the above-described components are added to a solvent is formed, and the coating film is dried and, as necessary, heated. Polyalkylsiloxane is added as a leveling agent to the coating solution for forming a charge transport layer.

Examples of the solvent for preparing the coating solution for forming a charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in the form of a mixture of two or more kinds thereof.

Examples of the coating method of coating the charge generation layer with the coating solution for forming a charge transport layer include typical methods such as a blade coating method, a wire bar coating method, a spray coating method, a dip coating method, a bead coating method, an air knife coating method, and a curtain coating method.

The film thickness of the charge transport layer is set to be, for example, preferably in a range of 5 μm or greater and 50 μm or less and more preferably in a range of 10 μm or greater and 30 μm or less.

### Protective Layer

A protective layer is provided on the photosensitive layer as necessary. The protective layer is provided, for example, for the purpose of preventing a chemical change in the photosensitive layer during charging and further improving the mechanical strength of the photosensitive layer.

Therefore, for example, a layer formed of a cured film (crosslinked film) may be applied to the protective layer. Examples of these layers include the layers described in the items 1) and 2) below.
1) A layer formed of a cured film of a composition containing a reactive group-containing charge transport material having a reactive group and a charge-transporting skeleton in an identical molecule (that is, a layer containing a polymer or a crosslinked body of the reactive group-containing charge transport material)
2) A layer formed of a cured film of a composition containing a non-reactive charge transport material and a reactive group-containing non-charge transport material containing a reactive group without having a charge-transporting skeleton (that is, a layer containing the non-reactive charge transport material and a polymer or crosslinked body of the reactive group-containing non-charge transport material)

Examples of the reactive group of the reactive group-containing charge transport material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn}[here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as the group is a functional group capable of radical polymerization and is, for example, a functional group containing a group having at least a carbon double bond. Specific examples thereof include a vinyl group, a vinyl ether group, a vinyl thioether group, a styryl group (vinylphenyl group), an acryloyl group, a methacryloyl group, and a group containing at least one selected from derivatives thereof. Among these, from the viewpoint that the reactivity is excellent, for example, a vinyl group, a styryl group (vinylphenyl group), an acryloyl group, a methacryloyl group, and a group containing at least one selected from derivatives thereof are preferable as the chain polymerizable group.

The charge-transporting skeleton of the reactive group-containing charge transport material is not particularly limited as long as the skeleton is a known structure in the electrophotographic photoreceptor, and examples thereof include a structure conjugated with a nitrogen atom, which is a skeleton derived from a nitrogen-containing positive hole-transporting compound such as a triarylamine-based compound, a benzidine-based compound, or a hydrazone-based compound. Among these, for example, a triarylamine skeleton is preferable.

The reactive group-containing charge transport material having the reactive group and the charge-transporting skeleton, the non-reactive charge transport material, and the reactive group-containing non-charge transport material may be selected from known materials.

The protective layer may also contain other known additives.

The formation of the protective layer is not particularly limited, and a known forming method is used. For example, a coating film of a coating solution for forming a protective layer in which the above-described components are added to a solvent is formed, and the coating film is dried and, as necessary, subjected to a curing treatment such as heating.

Examples of the solvent for preparing the coating solution for forming a protective layer include an aromatic solvent such as toluene or xylene; a ketone-based solvent such as methyl ethyl ketone, methyl isobutyl ketone, or cyclohexanone; an ester-based solvent such as ethyl acetate or butyl acetate; an ether-based solvent such as tetrahydrofuran or dioxane; a cellosolve-based solvent such as ethylene glycol monomethyl ether; and an alcohol-based solvent such as isopropyl alcohol or butanol. These solvents are used alone or in the form of a mixture of two or more kinds thereof. The coating solution for forming a protective layer may be a solvent-less coating solution.

Examples of the method of coating the photosensitive layer (such as the charge transport layer) with the coating solution for forming a protective layer include typical coating methods such as a dip coating method, a push-up coating method, a wire bar coating method, a spray coating method, a blade coating method, an air knife coating method, and a curtain coating method.

The film thickness of the protective layer is set to be, for example, preferably in a range of 1 μm or greater and 20 μm or less and more preferably in a range of 2 μm or greater and 10 m or less.

### Single Layer Type Photosensitive Layer

The single layer type photosensitive layer contains polyalkylsiloxane. The form of the polyalkylsiloxane is as described above.

The single layer type photosensitive layer (charge generation/charge transport layer) is, for example, a layer containing a charge generation material, a charge transport material, a binder resin, and as necessary, other known additives. These materials are the same as the materials described in the sections of the charge generation layer and the charge transport layer.

In the photoreceptor according to the second exemplary embodiment, for example, it is preferable that the single layer type photosensitive layer contains a phthalocyanine-based pigment as a charge generation material. As the phthalocyanine-based pigment contained in the single layer type photosensitive layer, for example, at least one selected from the following phthalocyanine group is preferable.

Phthalocyanine group: Y-titanyl phthalocyanine having diffraction peaks where Bragg angles (2θ+0.5°) in an X-ray diffraction spectrum using Cuka characteristic X-rays are at least 9.5° and 27.3°, B-titanyl phthalocyanine having diffraction peaks where the Bragg angles are at least 7.5° and 28.6°, hydroxygallium phthalocyanine having diffraction peaks where the Bragg angles are at least 7.8° and 28.6°, and chlorogallium phthalocyanine having diffraction peaks where the Bragg angles are at least 7.9° and 28.8°.

Even among the above-described phthalocyanine-based pigments, for example, at least one selected from the following phthalocyanine group is more preferable.

Phthalocyanine group: hydroxygallium phthalocyanine having diffraction peaks where Bragg angles (2θ+0.5°) in an X-ray diffraction spectrum using Cuka characteristic X-rays are at least 7.8° and 28.6° and chlorogallium phthalocyanine having diffraction peaks where the Bragg angles are at least 7.9° and 28.8°.

The content of the charge generation material in the single layer type photosensitive layer may be, for example, 0.1% by mass or greater and 10% by mass or less and preferably 0.8% by mass or greater and 5% by mass or less with respect to the total solid content. Further, the content of the charge transport material in the single layer type photosensitive layer may be, for example, 5% by mass or greater and 50% by mass or less with respect to the total solid content.

The method of forming the single layer type photosensitive layer is the same as the method of forming the charge generation layer or the charge transport layer. Polyalkylsiloxane is added as a leveling agent to the coating solution for forming a single layer type photosensitive layer.

The film thickness of the single layer type photosensitive layer may be, for example, 5 m or greater and 50 μm or less and preferably 10 μm or greater and 40 μm or less.

### Process Cartridge and Image Forming Apparatus

An image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image to a surface of a recording medium. Further, the electrophotographic photoreceptor according to the present exemplary embodiment is employed as the electrophotographic photoreceptor.

As the image forming apparatus according to the present exemplary embodiment, known image forming apparatuses such as an apparatus including a fixing device that fixes a toner image transferred to the surface of a recording medium; a direct transfer type apparatus that transfers a toner image formed on the surface of an electrophotographic photoreceptor directly to a recording medium; an intermediate transfer type apparatus that primarily transfers a toner image formed on the surface of an electrophotographic photoreceptor to the surface of an intermediate transfer member and secondarily transfers the toner image transferred to the surface of the intermediate transfer member to the surface of a recording medium; an apparatus including a cleaning device that cleans the surface of an electrophotographic photoreceptor after the transfer of a toner image and before the charging; an apparatus including a destaticizing device that destaticizes the surface of an electrophotographic photoreceptor by irradiating the surface with destaticizing light after the transfer of a toner image and before the charging; and an apparatus including an electrophotographic photoreceptor heating member for increasing the temperature of an electrophotographic photoreceptor and decreasing the relative temperature are employed.

In a case of the intermediate transfer type apparatus, the transfer device is, for example, configured to include an intermediate transfer member having a surface onto which the toner image is transferred, a primary transfer device primarily transferring the toner image formed on the surface of the electrophotographic photoreceptor to the surface of the intermediate transfer member, and a secondary transfer device secondarily transferring the toner image transferred to the surface of the intermediate transfer member to the surface of the recording medium.

The image forming apparatus according to the present exemplary embodiment may be any of a dry development type image forming apparatus or a wet development type (development type using a liquid developer) image forming apparatus.

In the image forming apparatus according to the present exemplary embodiment, for example, the portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

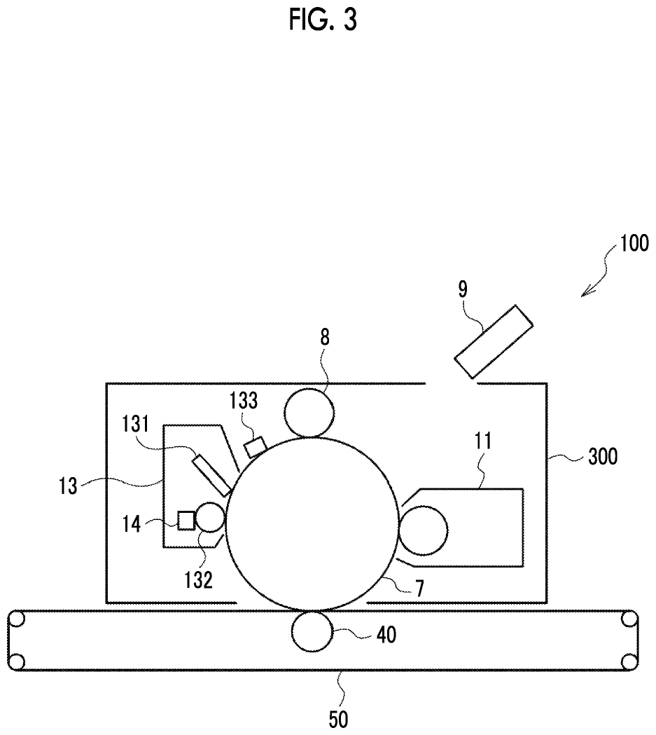

FIG. 3 is a schematic configuration view showing an example of an image forming apparatus according to the present exemplary embodiment.

As shown in FIG. 3, an image forming apparatus 100 according to the present exemplary embodiment includes a process cartridge 300 including an electrophotographic photoreceptor 7, an exposure device 9 (an example of an electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 3 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of the cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 3 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

### Charging Device

As the charging device 8, for example, a contact-type charger formed of a conductive or semi-conductive charging roller, a charging brush, a charging film, a charging rubber blade, a charging tube, or the like is used. Further, a known charger such as a non-contact type roller charger, or a scorotron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. The wavelength of the light source is within the spectral sensitivity region of the electrophotographic photoreceptor. As the wavelength of a semiconductor laser, near infrared, which has an oscillation wavelength in the vicinity of 780 nm, is mostly used. However, the wavelength is not limited thereto, and a laser having an oscillation wavelength of approximately 600 nm or a laser having an oscillation wavelength of 400 nm or greater and 450 nm or less as a blue laser may also be used. Further, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the developing device has the above-described functions, and is selected depending on the purpose thereof. Examples of the developing device include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

### Cleaning Device

As the cleaning device 13, a cleaning blade type device including the cleaning blade 131 is used. In addition to the cleaning blade type device, a fur brush cleaning type device or a simultaneous development cleaning type device may be employed.

### Transfer Device

Examples of the transfer device 40 include a known transfer charger such as a contact type transfer charger using a belt, a roller, a film, or a rubber blade, a scorotron transfer charger, or a corotron transfer charger using corona discharge.

### Intermediate Transfer Member

As the intermediate transfer member 50, a belt-like intermediate transfer member (intermediate transfer belt) containing semi-conductive polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

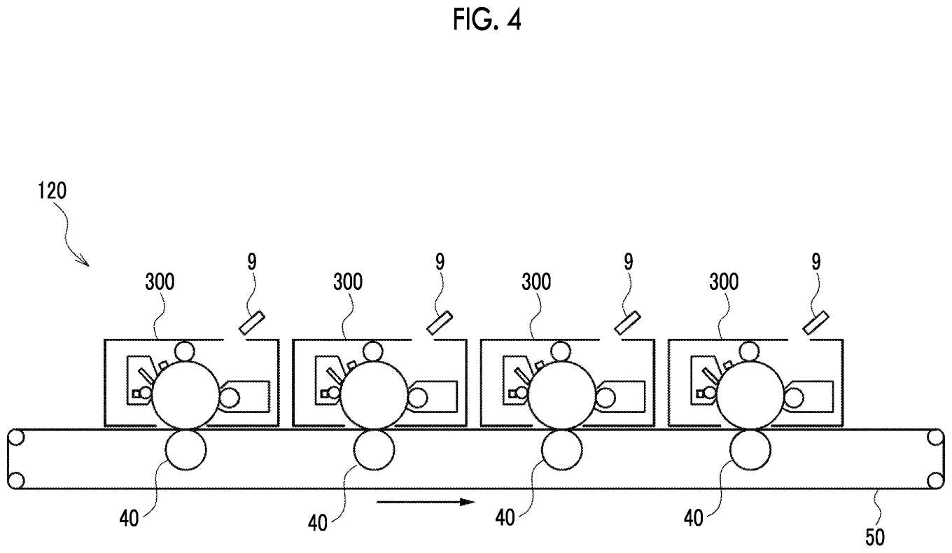

FIG. 4 is a schematic configuration view showing an example of an image forming apparatus according to the present exemplary embodiment.

An image forming apparatus 120 shown in FIG. 4 is a tandem type multicolor image forming apparatus on which four process cartridges 300 are mounted. The image forming apparatus 120 is formed such that four process cartridges 300 are arranged in parallel on the intermediate transfer member 50, and one electrophotographic photoreceptor is used for each color. The image forming apparatus 120 has the same configuration as the image forming apparatus 100 except that the image forming apparatus 120 is of a tandem type.

### Examples

Hereinafter, exemplary embodiments of the invention will be described in detail based on examples, but the exemplary embodiments of the invention are not limited to the examples.

In the following description, “parts” and “%” are on a mass basis unless otherwise specified.

In the following description, the synthesis, the treatment, the production, and the like are carried out at room temperature (25° C.±3° C.) unless otherwise specified.

### Production of Leveling Agent Solution

### Leveling Agent Solution (1)

KP340 (weight-average molecular weight of 8000, Shin-Etsu Chemical Co., Ltd.) containing dimethylpolysiloxane as an active component (that is, polyalkylsiloxane) is placed in a constant temperature drying furnace and maintained at 300° C. for 4 hours to evaporate components having a low boiling point. The substance dried and hardened by the heat treatment is dissolved in toluene such that the content of the substance reaches 10% by mass, thereby obtaining a leveling agent solution (1).

### Leveling Agent Solution (2)

Octamethylcyclotetrasiloxane (Tokyo Chemical Industry Co., Ltd.) in an amount corresponding to 1.8% by mass of the amount of the active component in the leveling agent solution (1) is added to the leveling agent solution (1), thereby obtaining a leveling agent solution (2).

### Leveling Agent Solution (3)

Decamethylcyclopentasiloxane (Tokyo Chemical Industry Co., Ltd.) in an amount corresponding to 1.8% by mass of the amount of the active component in the leveling agent solution (1) is added to the leveling agent solution (1), thereby obtaining a leveling agent solution (3).

### Leveling Agent Solution (4)

Dodecamethylcyclohexasiloxane (Tokyo Chemical Industry Co., Ltd.) in an amount corresponding to 1.8% by mass of the amount of the active component in the leveling agent solution (1) is added to the leveling agent solution (1), thereby obtaining a leveling agent solution (4).

### Leveling Agent Solution (5)

Octamethylcyclotetrasiloxane (Tokyo Chemical Industry Co., Ltd.) in an amount corresponding to 6.0% by mass of the amount of the active component in the leveling agent solution (1) is added to the leveling agent solution (1), thereby obtaining a leveling agent solution (5).

### Leveling Agent Solution (6)

Decamethylcyclopentasiloxane (Tokyo Chemical Industry Co., Ltd.) in an amount corresponding to 6.0% by mass of the amount of the active component in the leveling agent solution (1) is added to the leveling agent solution (1), thereby obtaining a leveling agent solution (6).

### Leveling Agent Solution (7)

Dodecamethylcyclohexasiloxane (Tokyo Chemical Industry Co., Ltd.) in an amount corresponding to 6.0% by mass of the amount of the active component in the leveling agent solution (1) is added to the leveling agent solution (1), thereby obtaining a leveling agent solution (7).

### Preparation of Charge Generation Material

The following charge generation materials are prepared.
Charge generation material (1): hydroxygallium phthalocyanine having diffraction peaks where Bragg angles (2θ+0.5°) in an X-ray diffraction spectrum using Cuka characteristic X-rays are at least 7.8° and 28.6°
Charge generation material (2): chlorogallium phthalocyanine having diffraction peaks where Bragg angles (2θ+0.5°) in an X-ray diffraction spectrum using Cuka characteristic X-rays are at least 7.9° and 28.8°
Charge generation material (3): Y-titanyl phthalocyanine having diffraction peaks where Bragg angles (2θ+0.5°) in an X-ray diffraction spectrum using Cuka characteristic X-rays are at least 9.5° and 27.3°

### Production of Photoreceptor Including Lamination Type Photosensitive Layer

### Example S1

### Formation of Undercoat Layer

100 parts of zinc oxide (average particle diameter of 70 nm, specific surface area of 15 m²/g, manufactured by Tayca Corporation) is stirred and mixed with 500 parts of tetrahydrofuran, 1.4 parts of a silane coupling agent (KBE503, manufactured by Shin-Etsu Chemical Co., Ltd.) is added thereto, and the mixture is stirred for 2 hours. Thereafter, toluene is distilled off by vacuum distillation and baked at a temperature of 120° C. for 3 hours to obtain zinc oxide surface-treated with a silane coupling agent.

110 parts of the surface-treated zinc oxide is stirred and mixed with 500 parts of tetrahydrofuran, a solution in which 0.6 parts of alizarin is dissolved in 50 parts of tetrahydrofuran is added thereto, and the mixture is stirred at a temperature of 50° C. for 5 hours. Thereafter, the solid content is separated by filtration by carrying out filtration under reduced pressure and dried at a temperature of 60° C. under reduced pressure, thereby obtaining zinc oxide with alizarin.

A mixed solution is obtained by mixing 60 parts of the zinc oxide with alizarin, 13.5 parts of a curing agent (blocked isocyanate, SUMIDUR 3175, manufactured by Sumitomo Bayer Urethane Co., Ltd.), 15 parts of a butyral resin (S-LEC BM-1, manufactured by Sekisui Chemical Co., Ltd.), and 85 parts of methyl ethyl ketone. 38 parts of this mixed solution and 25 parts of methyl ethyl ketone are mixed and dispersed for 2 hours with a sand mill using glass beads having a diameter of 1 mm, thereby obtaining a dispersion liquid. 0.005 part of dioctyltin dilaurate as a catalyst and 30 parts of silicone resin particles (TOSPEARL 145, manufactured by Momentive Performance Materials Inc.) are added to the dispersion liquid, thereby obtaining a coating solution for an undercoat layer.

A conductive substrate (cylindrical aluminum substrate) is coated with the coating solution for an undercoat layer by a dip coating method, and heated and dried at a temperature of 170° C. for 30 minutes, thereby forming an undercoat layer with an average thickness of 32 μm.

### Formation of Charge Generation Layer

1 part of the charge generation material (1) is mixed with 1 part of polyvinyl butyral (S-LEC BM-5, manufactured by Sekisui Chemical Co., Ltd.) and 80 parts of n-butyl acetate, and the mixture is subjected to a dispersion treatment with glass beads and a paint shaker for 1 hour, thereby preparing a coating solution for a charge generation layer. The undercoat layer is immersed in and coated with the coating solution for forming a charge generation layer, and heated and dried at a temperature of 130° C. for 10 minutes, thereby forming a charge generation layer with an average thickness of 0.15 μm.

### Formation of Charge Transport Layer

45 parts of CTM1 as a charge transport material and 55 parts of a polycarbonate resin (viscosity average molecular weight of 40,000) having PCZ1 as a constitutional unit as a binder resin are dissolved in 350 parts of toluene and 150 parts of tetrahydrofuran, and 8 parts of polytetrafluoroethylene resin particles (average particle diameter of 300 nm, LUBRON L5, Daikin Industries, Ltd.) are added to the mixture. Further, the leveling agent solution (1) is added in an amount such that the amount of the active component (that is, polyalkylsiloxane) reaches 5 ppm with respect to the total solid content. Next, the mixture is treated with a high-pressure homogenizer 5 times, thereby preparing a coating solution for a charge transport layer. The charge generation layer is immersed in and coated with the coating solution for forming a charge transport layer, and heated and dried at a temperature of 130° C. for 45 minutes, thereby forming a charge transport layer with an average thickness of 45 μm.

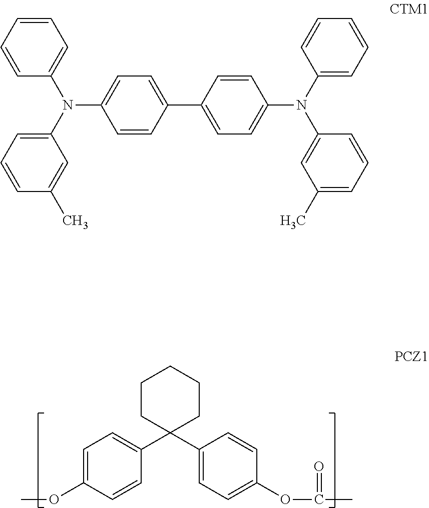

### Examples S2 to S8 and Comparative Examples S1 to S5

Each photoreceptor is produced in the same manner as in Example S1 except that the kind of the charge generation material of the charge generation layer and the kind of the leveling agent solution of the charge transport layer are changed as listed in Table 1.

### Production of Photoreceptor Including Single Layer Type Photosensitive Layer

### Example T1

### Formation of Photosensitive Layer

Charge generation material (1) . . . 1 part
Electron transport material: ETM-1 . . . 9 parts
Charge transport material: CTM-1 . . . 45 parts
Binder resin: polycarbonate resin having PCZ1 as constitutional unit . . . 45 parts

The above-described materials are dissolved or dispersed in a mixed solvent of 175 parts of tetrahydrofuran and 75 parts of toluene, and the solution is subjected to a dispersion treatment for 4 hours with a sand mill using glass beads having a diameter of 1 mm. Further, the leveling agent solution (1) is added in an amount such that the amount of the active component (that is, polyalkylsiloxane) reaches 5 ppm with respect to the total solid content, and the solution is subjected to a dispersion treatment, thereby obtaining a coating solution for forming a photosensitive layer. An outer peripheral surface of a conductive substrate (cylindrical aluminum substrate) is coated with the coating solution for forming a photosensitive layer by a dip coating method, and dried at a temperature of 150° C. for 60 minutes, thereby forming a single layer type photosensitive layer having an average thickness of 36 μm.

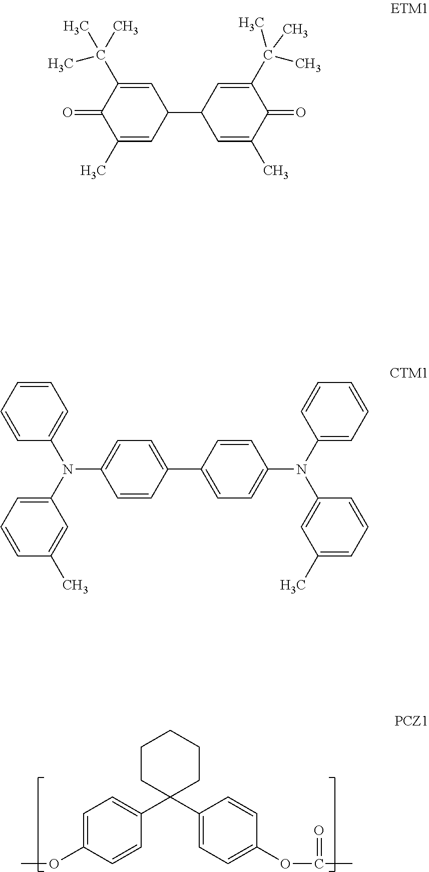

### Example T2 and Comparative Example T1

Each photoreceptor is produced in the same manner as in Example T1 except that the kind of the leveling agent solution of the charge transport layer is changed as listed in Table 2.

### Performance Evaluation of Photoreceptor

### Low-Molecular-Weight Cyclic Siloxane Content

The content of low-molecular-weight cyclic siloxane in the charge transport layer is determined by the method described above. The results are listed in Tables 1 and 2.

### Image Quality

An electrophotographic image forming apparatus DocuCentre IV C2260 (manufactured by FUJIFILM Business Innovation Corporation) is prepared, and the photoreceptor of each example or each comparative example is installed. 1,000 sheets of black images with an image density of 50% are continuously output onto A4 plain paper in a high-temperature and high-humidity (temperature of 30° C. and relative humidity of 850) environment. The presence or absence of spot-like image defects and image unevenness in the 1,000th image is visually observed, and the degree of the image defects is classified into the following items A to E. The results are listed in Tables 1 and 2.
A: Image defects are not found.
B: Minor image defects have partially occurred at an acceptable level of quality.
C: Minor image defects have occurred at an acceptable level of quality.
D Image defects have occurred at an acceptable level of quality.
E: Image defects have occurred at an unacceptable level of quality.
The abbreviations listed in Tables 1 and 2 stand for the following compounds.
D4: octamethylcyclotetrasiloxane
D5: decamethylcyclopentasiloxane
D6: dodecamethylcyclohexasiloxane

TABLE 1

| | Charge generation | Charge transport layer | | | | |
|---|---|---|---|---|---|---|
| | layer | | | Low-molecular- | Content of low- | |
| | Charge generation | Leveling agent | Content of | weight cyclic | molecular-weight | |
| | material | solution | polyalkylsiloxane | siloxane | cyclic siloxane | Image |
| | Type | Type | ppm | Type | ppm | quality |
| Example S1 | 1 | 1 | 5 | — | 0.00 | A |
| Example S2 | 1 | 2 | 5 | D4 | 0.09 | B |
| Example S3 | 1 | 3 | 5 | D5 | 0.09 | B |
| Example S4 | 1 | 4 | 5 | D6 | 0.09 | B |
| Comparative | 1 | 5 | 5 | D4 | 0.30 | E |
| Example S1 | | | | | | |
| Comparative | 1 | 6 | 5 | D5 | 0.30 | E |
| Example S2 | | | | | | |
| Comparative | 1 | 7 | 5 | D6 | 0.30 | E |
| Example S3 | | | | | | |
| Example S5 | 2 | 1 | 5 | — | 0.00 | A |
| Example S6 | 2 | 2 | 5 | D4 | 0.09 | B |
| Comparative | 2 | 5 | 5 | D4 | 0.30 | E |
| Example S4 | | | | | | |
| Example S7 | 3 | 1 | 5 | — | 0.00 | C |
| Example S8 | 3 | 2 | 5 | D4 | 0.09 | D |
| Comparative | 3 | 5 | 5 | D4 | 0.30 | E |
| Example S5 | | | | | | |

TABLE 2

| | Single layer type photosensitive layer | | | | | |
|---|---|---|---|---|---|---|
| | | | | Low-molecular- | Content of low- | |
| | Charge generation | Leveling agent | Content of | weight cyclic | molecular-weight | |
| | material | solution | polyalkylsiloxane | siloxane | cyclic siloxane | Image |
| | Type | Type | ppm | Type | ppm | quality |
| Example T1 | 1 | 1 | 5 | — | 0.00 | A |
| Example T2 | 1 | 2 | 5 | D4 | 0.09 | B |
| Comparative | 1 | 5 | 5 | D4 | 0.30 | E |
| Example T1 | | | | | | |

The electrophotographic photoreceptor, the process cartridge, and the image forming apparatus of the present disclosure include the following aspects.

(((1)))

An electrophotographic photoreceptor comprising:
a conductive substrate; and
a lamination type photosensitive layer disposed on the conductive substrate and including a charge generation layer and a charge transport layer,
wherein the charge transport layer contains polyalkylsiloxane, and
an amount of a cyclic siloxane having a molecular weight of 450 or less in the charge transport layer is less than 0.1 ppm.

(((2)))

The electrophotographic photoreceptor according to (((1))),
wherein the charge transport layer does not contain the cyclic siloxane having a molecular weight of 450 or less.

(((3)))

The electrophotographic photoreceptor according to (((1))) or (((2))),
wherein a content of the polyalkylsiloxane contained in the charge transport layer is 1 ppm or greater and 10 ppm or less.

(((4)))

The electrophotographic photoreceptor according to any one of (((1))) to (((3))),
wherein the charge generation layer contains a phthalocyanine-based pigment that is a charge generation material.

(((5)))

The electrophotographic photoreceptor according to (((4))),
wherein the phthalocyanine-based pigment contains at least one selected from the following phthalocyanine group,
phthalocyanine group: Y-titanyl phthalocyanine having diffraction peaks where Bragg angles (2θ+0.5°) in an X-ray diffraction spectrum using Cuka characteristic X-rays are at least 9.5° and 27.3°, B-titanyl phthalocyanine having diffraction peaks where the Bragg angles are at least 7.5° and 28.6°, hydroxygallium phthalocyanine having diffraction peaks where the Bragg angles are at least 7.8° and 28.6°, and chlorogallium phthalocyanine having diffraction peaks where the Bragg angles are at least 7.9° and 28.8°.

(((6)))

The electrophotographic photoreceptor according to (((4))),
wherein the phthalocyanine-based pigment contains at least one selected from the following phthalocyanine group,
phthalocyanine group: hydroxygallium phthalocyanine having diffraction peaks where Bragg angles (2θ+0.5°) in an X-ray diffraction spectrum using Cuka characteristic X-rays are at least 7.8° and 28.6° and chlorogallium phthalocyanine having diffraction peaks where the Bragg angles are at least 7.9° and 28.8°.

(((7)))

An electrophotographic photoreceptor comprising:
a conductive substrate; and
a single layer type photosensitive layer disposed on the conductive substrate,
wherein the single layer type photosensitive layer contains polyalkylsiloxane, and
an amount of a cyclic siloxane having a molecular weight of 450 or less in the single layer type photosensitive layer is less than 0.1 ppm.

(((8)))

The electrophotographic photoreceptor according to (((7))),
wherein the single layer type photosensitive layer does not contain the cyclic siloxane having a molecular weight of 450 or less.

(((9)))

The electrophotographic photoreceptor according to (((7))) or (((8))),
wherein a content of the polyalkylsiloxane contained in the single layer type photosensitive layer is 1 ppm or greater and 10 ppm or less.

(((10)))

The electrophotographic photoreceptor according to any one of (((7))) to (((9))),
wherein the single layer type photosensitive layer contains a phthalocyanine-based pigment that is a charge generation material.

(((11)))

The electrophotographic photoreceptor according to (((10))),
wherein the phthalocyanine-based pigment contains at least one selected from the following phthalocyanine group,
phthalocyanine group: Y-titanyl phthalocyanine having diffraction peaks where Bragg angles (2θ+0.5°) in an X-ray diffraction spectrum using Cuka characteristic X-rays are at least 9.5° and 27.3°, B-titanyl phthalocyanine having diffraction peaks where the Bragg angles are at least 7.5° and 28.6°, hydroxygallium phthalocyanine having diffraction peaks where the Bragg angles are at least 7.8° and 28.6°, and chlorogallium phthalocyanine having diffraction peaks where the Bragg angles are at least 7.9° and 28.8°.

(((12)))

The electrophotographic photoreceptor according to (((10))),
wherein the phthalocyanine-based pigment contains at least one selected from the following phthalocyanine group,
phthalocyanine group: hydroxygallium phthalocyanine having diffraction peaks where Bragg angles (2θ+0.5°) in an X-ray diffraction spectrum using Cuka characteristic X-rays are at least 7.8° and 28.6° and chlorogallium phthalocyanine having diffraction peaks where the Bragg angles are at least 7.9° and 28.8°.

(((13)))

A process cartridge comprising:
the electrophotographic photoreceptor according to any one of (((1))) to (((12))),
wherein the process cartridge is attachable to and detachable from an image forming apparatus.

(((14)))

An image forming apparatus comprising:
the electrophotographic photoreceptor according to any one of (((1))) to (((12)));
a charging unit that charges a surface of the electrophotographic photoreceptor;
an electrostatic latent image forming unit that forms an electrostatic latent image on the charged surface of the electrophotographic photoreceptor;
a developing unit that develops the electrostatic latent image formed on the surface of the electrophotographic photoreceptor with a developer containing a toner to form a toner image; and
a transfer unit that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate; and
a lamination type photosensitive layer disposed on the conductive substrate and including a charge generation layer and a charge transport layer,
wherein the charge transport layer contains polyalkylsiloxane, and
an amount of a cyclic siloxane having a molecular weight of 450 or less in the charge transport layer is less than 0.1 ppm.

2. The electrophotographic photoreceptor according to claim 1,
wherein the charge transport layer does not contain the cyclic siloxane having a molecular weight of 450 or less.

3. The electrophotographic photoreceptor according to claim 1,
wherein a content of the polyalkylsiloxane contained in the charge transport layer is 1 ppm or greater and 10 ppm or less.

4. The electrophotographic photoreceptor according to claim 1,
wherein the charge generation layer contains a phthalocyanine-based pigment that is a charge generation material.

5. The electrophotographic photoreceptor according to claim 4,
wherein the phthalocyanine-based pigment contains at least one selected from the following phthalocyanine group,
phthalocyanine group: Y-titanyl phthalocyanine having diffraction peaks where Bragg angles (2θ+0.5°) in an X-ray diffraction spectrum using Cukα characteristic X-rays are at least 9.5° and 27.3°, B-titanyl phthalocyanine having diffraction peaks where the Bragg angles are at least 7.5° and 28.6°, hydroxygallium phthalocyanine having diffraction peaks where the Bragg angles are at least 7.8° and 28.6°, and chlorogallium phthalocyanine having diffraction peaks where the Bragg angles are at least 7.9° and 28.8°.

6. The electrophotographic photoreceptor according to claim 4,
wherein the phthalocyanine-based pigment contains at least one selected from the following phthalocyanine group,
phthalocyanine group: hydroxygallium phthalocyanine having diffraction peaks where Bragg angles (2θ+0.5°) in an X-ray diffraction spectrum using Cukα characteristic X-rays are at least 7.8° and 28.6° and chlorogallium phthalocyanine having diffraction peaks where the Bragg angles are at least 7.9° and 28.8°.

7. An electrophotographic photoreceptor comprising:
a conductive substrate; and
a single layer type photosensitive layer disposed on the conductive substrate,
wherein the single layer type photosensitive layer contains polyalkylsiloxane, and
an amount of a cyclic siloxane having a molecular weight of 450 or less in the single layer type photosensitive layer is less than 0.1 ppm.

8. The electrophotographic photoreceptor according to claim 7,
wherein the single layer type photosensitive layer does not contain the cyclic siloxane having a molecular weight of 450 or less.

9. The electrophotographic photoreceptor according to claim 7,
wherein a content of the polyalkylsiloxane contained in the single layer type photosensitive layer is 1 ppm or greater and 10 ppm or less.

10. The electrophotographic photoreceptor according to claim 7,
wherein the single layer type photosensitive layer contains a phthalocyanine-based pigment that is a charge generation material.

11. The electrophotographic photoreceptor according to claim 10,
wherein the phthalocyanine-based pigment contains at least one selected from the following phthalocyanine group,
phthalocyanine group: Y-titanyl phthalocyanine having diffraction peaks where Bragg angles (2θ+0.5°) in an X-ray diffraction spectrum using Cukα characteristic X-rays are at least 9.5° and 27.3°, B-titanyl phthalocyanine having diffraction peaks where the Bragg angles are at least 7.5° and 28.6°, hydroxygallium phthalocyanine having diffraction peaks where the Bragg angles are at least 7.8° and 28.6°, and chlorogallium phthalocyanine having diffraction peaks where the Bragg angles are at least 7.9° and 28.8°.

12. The electrophotographic photoreceptor according to claim 10,
wherein the phthalocyanine-based pigment contains at least one selected from the following phthalocyanine group,
phthalocyanine group: hydroxygallium phthalocyanine having diffraction peaks where Bragg angles (2θ+0.5°) in an X-ray diffraction spectrum using Cukα characteristic X-rays are at least 7.8° and 28.6° and chlorogallium phthalocyanine having diffraction peaks where the Bragg angles are at least 7.9° and 28.8°.

13. A process cartridge comprising:
the electrophotographic photoreceptor according to claim 1,
wherein the process cartridge is attachable to and detachable from an image forming apparatus.

14. A process cartridge comprising:
the electrophotographic photoreceptor according to claim 2,
wherein the process cartridge is attachable to and detachable from an image forming apparatus.

15. A process cartridge comprising:
the electrophotographic photoreceptor according to claim 3,
wherein the process cartridge is attachable to and detachable from an image forming apparatus.

16. A process cartridge comprising:
the electrophotographic photoreceptor according to claim 4,
wherein the process cartridge is attachable to and detachable from an image forming apparatus.

17. A process cartridge comprising:
the electrophotographic photoreceptor according to claim 5,
wherein the process cartridge is attachable to and detachable from an image forming apparatus.

18. A process cartridge comprising:
the electrophotographic photoreceptor according to claim 6,
wherein the process cartridge is attachable to and detachable from an image forming apparatus.

19. A process cartridge comprising:
the electrophotographic photoreceptor according to claim 7,
wherein the process cartridge is attachable to and detachable from an image forming apparatus.

20. An image forming apparatus comprising:
the electrophotographic photoreceptor according to claim 1;
a charging unit that charges a surface of the electrophotographic photoreceptor;
an electrostatic latent image forming unit that forms an electrostatic latent image on the charged surface of the electrophotographic photoreceptor;
a developing unit that develops the electrostatic latent image formed on the surface of the electrophotographic photoreceptor with a developer containing a toner to form a toner image; and
a transfer unit that transfers the toner image to a surface of a recording medium.
